(19) United States
(12) Patent Application Publication
(10) Pub. No.: US 2020/0259527 A1
(43) Pub. Date: Aug. 13, 2020

(54) Decoding of a Signal Comprising Encoded Data Symbols

(71) Applicant: Telefonaktiebolaget LM Ericsson (publ), Stockholm (SE)

(72) Inventors: Miguel Lopez, Solna (SE); Stefan Eriksson Löwenmark, Färentuna (SE)

(21) Appl. No.: 16/759,010

(22) PCT Filed: Oct. 30, 2017
(86) PCT No.: PCT/SE2017/051060

§ 371 Date: Apr. 24, 2020

(51) Int. Cl. H04B 7/02; H04J 13/00

(52) U.S. Cl. CPC H04B 7/02; H04J 13/0048

(57) ABSTRACT

A first radio node (108-1,108-2; 110) and a method therein for transmitting a signal comprising encoded data symbols to a second radio node (110; 108-1,108-2). The first and second radio nodes are operating in a wireless communications network (100). The 5 first radio node repeats n times a sequence of data symbols S0,S1, . . . ,Sk−1 to be transmitted, wherein k is a multiple of n. The first radio node encodes the n sequences of data symbols S0,S1, . . . ,Sk−1 using n orthogonal code sequences, wherein each code sequence comprises n code elements. Further, the first radio node transmits, to the second radio node, a signal comprising the respective encoded sequence of data 10 symbols S0,S1, Sk−1 and an optional respective affix for separating two encoded sequences of data symbols S0,S1, . . . ,Sk−1.

### TECHNICAL FIELD

Embodiments herein relate generally to a first radio node, a second radio node and to methods therein. In particular, embodiments relate to respective transmission and decoding of a signal comprising encoded data symbols.

### BACKGROUND

Communication devices such as terminals or wireless devices are also known as e.g. User Equipments (UEs), mobile terminals, wireless terminals and/or mobile stations. Such terminals are enabled to communicate wirelessly in a wireless communication system or a cellular communications network, sometimes also referred to as a cellular radio system or cellular networks. The communication may be performed e.g. between two wireless devices, between a wireless device and a regular telephone and/or between a wireless device and a server via a Radio Access Network (RAN) and possibly one or more core networks, comprised within the wireless communications network.

The above terminals or wireless devices may further be referred to as mobile telephones, cellular telephones, laptops, or tablets with wireless capability, just to mention some further examples. The terminals or wireless devices in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area being served by an access node such as a base station, e.g. a Radio Base Station (RBS), which sometimes may be referred to as e.g. an “eNB”, an “eNodeB”, a “NodeB”, a “B node”, or a Base Transceiver Station (BTS), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated at the base station site, may serve one or several cells. Further, each base station may support one or several communication technologies. The base stations communicate over the air interface operating on radio frequencies with the terminals or wireless devices within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code-division multiple access (WCDMA) and/or High-Speed Packet Access (HSPA) for user equipment. In a forum known as the

Third Generation Partnership Project (3GPP), telecommunications suppliers propose and agree upon standards for third and higher generation networks, and investigate enhanced data rate and radio capacity. In some RANs, e.g. as in UMTS, several radio network nodes may be connected, e.g., by landlines or microwave, to a controller node, such as a radio network controller (RNC) or a Base Station Controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3GPP and this work continues in the coming 3GPP releases, for example to specify a Fifth Generation (5G) network. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

In the 3GPP LTE, base stations, which may be referred to as eNodeBs or even eNBs, may be directly connected to one or more core networks.

The 3GPP LTE radio access standard has been written in order to support high bitrates and low latency both for uplink and downlink traffic. All data transmission is in LTE controlled by the radio base station.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO systems.

A single carrier transmission means that one Radio Frequency (RF) carrier is used to carry the data to be transmitted. Hence data in the form of bits is carried by one single RF carrier. A single carrier modulation is a modulation wherein data is modulated on a single Radio frequency (RF) carrier frequency. Single carrier modulations typically exhibit low Peak to Average Power Ratio (PAPR) and this property allows cost and power efficient transmitter implementations since there is no need to use power amplifiers with high linearity requirements, and there is no need to back-off the power amplifier. Single carrier modulations are often used in communications networks with low to moderate data rates, such as Bluetooth or Zigbee, but are also employed in high data rate communications networks, such as LTE uplink. Single carrier modulations are also appealing in new broadband wireless technologies like Visible Light Communications (VLC), again due to the low PAPR, as well as their ease of implementation.

Many broadband and Internet of Things (IoT) wireless communications technologies incorporate coverage enhancements as essential features in order to widen their appeal and applicability. For example, the IEEE 802.11ax standard, the IEEE 802.11ah standard, the Bluetooth Long Range (BLR), the Narrow Band IoT (NB-IoT), and the extended Coverage GSM (EC-GSM) provide extended coverage modes. Repetition codes are easy to implement as a means to enhance other channel codes, and sometimes they are essential components of a communications chain intended to provide extended coverage. By the expression “extended coverage” when used in this disclosure is meant that measures have been taken to allow a device to communicate with the network at lower received signal levels than in normal coverage (i.e., how the system was originally designed to operate). For example, when catering for devices in extended coverage, one common measure to take is to let the transmitter blindly repeat the transmitted information without waiting for an acknowledgement from the receiver. If the procedure on how the repetitions have been performed is known to the receiver, it can make use of that knowledge to maximize processing gain, and improve probability of decoding the transmitted information. Furthermore, repetitions can be useful for low power transmitters such as those found in e.g. backscattering radios.

Time dispersion on the radio channel as well as in filters in both the transmitter and receiver causes Inter-Symbol Interference (ISI), meaning that each received sample is a weighted sum of several transmitted symbols. The ISI is conventionally handled by an equalizer that attempts to resolve, e.g. extract, the transmitted symbols. Alternatively, non-coherent modulation/demodulation can be used. Radio channels with time dispersions is sometimes referred to as time dispersive radio channels or just time dispersive channels.

As mentioned above, an equalizer may be used to handle the ISI and to extract the transmitted symbols. However, equalization usually involves a high computational complexity. Suboptimal equalization algorithms exist with lower complexity at the cost of reduced performance. Further, prior to equalization, an estimation of the channel impulse response is needed, which requires that a number of consecutive training symbols are needed in the transmitted data. Since the number of training symbols does not scale with the number of useful data symbols, the overhead can be significant if a small number of useful data symbols is desired (allowing more repetitions in the same time period). Low complexity equalization is often a requirement in low end IoT devices, where low cost and low energy consumption are of great importance.

Non-coherent modulation techniques are well suited for low complexity receivers, since the equalization process is greatly simplified, but the price is a non-negligible loss in link performance.

### SUMMARY

According to developments of wireless communications networks improved modulation and demodulation methods are needed for improving the performance of the wireless communications network.

An object of embodiments herein is to address at least some drawbacks with the prior art and to improve the performance in the wireless communications network. For example, an object is to provide modulation and demodulation methods suitable for extended coverage in a single carrier wireless communications network, which modulation and demodulation methods provide good link performance with low computational complexity.

According to one aspect of embodiments herein, the object is achieved by a method performed by a first radio node for transmitting a signal comprising encoded data symbols to a second radio node. The first radio node and the second radio node are operating in a wireless communications network.

The first radio node repeats n times a sequence of data symbols S₀,S₁, . . . ,Skₖ₋₁ to be transmitted, wherein k is a multiple of n.

Further, the first radio node encodes the n sequences of data symbols S₀,S₁, . . . , Sₖ₋₁ using n orthogonal code sequences, wherein each code sequence comprises n code elements.

Furthermore, the first radio node transmits, to the second radio node, a signal comprising the respective encoded sequence of data symbols S₀,S₁, . . . , Skₖ₋₁ and an optional respective affix for separating two encoded sequences of data symbols S₀,S₁, . . . , Sₖ₋₁.

According to another aspect of embodiments herein, the object is achieved by a first radio node for transmitting a signal comprising encoded data symbols to a second radio node. The first radio node and the second radio node are configured to operate in a wireless communications network.

The first radio node is configured to repeat n times a sequence of data symbols S₀,S₁, . . . , Sₖ₋₁ to be transmitted, wherein k is a multiple of n.

Further, the first radio node is configured to encode the n sequences of data symbols S₀,S₁, . . . , Sₖ₋₁ using n orthogonal code sequences, wherein each code sequence comprises n code elements.

Furthermore, the first radio node is configured to transmit, to the second radio node, a signal comprising the respective encoded sequence of data symbols S₀,S₁, . . . , Sₖ₋₁ and an optional respective affix for separating two encoded sequences of data symbols S₀,S₁, . . . , Sₖ₋₁.

According to another aspect of embodiments herein, the object is achieved by a method performed by a second radio node for decoding and extracting data symbols from a signal received from a first radio node. The second radio node and the first radio node are operating in a wireless communications network.

The second radio node receives a signal from the first radio node and removes an affix from the received signal resulting in n sequences of k received samples.

Further, the second radio node stacks the n sequences of k received samples.

Furthermore, the second radio node decodes the stacked n sequences of k received samples using n orthogonal code sequences, wherein each code sequence comprises n code elements. For each code sequence, the second radio node multiplies each of the n sequences of k received samples to one out of the n code elements of the code sequence. The second radio node subsequently adds the multiplied sequences of received samples. The decoding results in n different decoded sequences of samples of length k each decoded sequence of samples corresponding to one of the n applied code sequences.

Yet further, the second radio node extracts a sequence of data symbols S₀,S₁, . . . , Sₖ₋₁ from the n different decoded sequences of samples.

According to another aspect of embodiments herein, the object is achieved by a second radio node for decoding and extracting data symbols from a signal received from a first radio node. The second radio node and the first radio node are configured to operate in a wireless communications network.

The second radio node is configured to receive a signal from the first radio node and removes an affix from the received signal resulting in n sequences of k received samples.

Further, the second radio node is configured to stack the n sequences of k received samples.

Furthermore, the second radio node is configured to decode the stacked n sequences of k received samples using n orthogonal code sequences, wherein each code sequence comprises n code elements. For each code sequence, the second radio node is configured to multiply each of the n sequences of k received samples to one out of the n code elements of the code sequence. The second radio node is configured to subsequently add the multiplied sequences of received samples. The decoding results in n different decoded sequences of samples of length k each decoded sequence of samples corresponding to one of the n applied code sequences.

Yet further, the second radio node is configured to extract a sequence of data symbols S₀,S₁, . . . , Sₖ₋₁ from the n different decoded sequences of samples.

According to another aspect of embodiments herein, the object is achieved by a computer program, comprising instructions which, when executed on at least one processor, causes the at least one processor to carry out the method performed by the first radio node.

According to another aspect of embodiments herein, the object is achieved by a computer program, comprising instructions which, when executed on at least one processor, causes the at least one processor to carry out the method performed by the second radio node.

According to another aspect of embodiments herein, the object is achieved by a carrier comprising the computer program, wherein the carrier is one of an electronic signal, an optical signal, a radio signal or a computer readable storage medium.

Since the first radio node transmits n times repeated sequences of data symbols S₀,S₁, . . . , Sₖ₋₁ that have been encoded using n orthogonal code sequences, and since the second radio node uses the n orthogonal code sequences when extracting the transmitted data symbols, the inter-symbol interference is resolved without the need of equalization and channel estimation. Thereby providing a simplified procedure. This results in an improved performance in the communications network.

Thus, an advantage with embodiments herein is that the need for equalization is eliminated, enabling a low complexity receiver, but preserving the performance of receivers using computationally complex coherent equalization and demodulation.

Another advantage with embodiments herein is that the number of training symbols may be reduced, giving a lower overhead and increasing the spectrum efficiency.

### BRIEF DESCRIPTION OF DRAWINGS

Examples of embodiments herein are described in more detail with reference to attached drawings in which:

FIG. 1 schematically illustrates embodiments of a wireless communications network;

FIG. 2 is a flowchart schematically illustrating embodiments of a method performed by a first radio node;

FIG. 3 is a block diagram schematically illustrating embodiments of a first radio node;

FIG. 4 is a flowchart schematically illustrating embodiments of a method performed by a second radio node;

FIG. 5 is a block diagram schematically illustrating embodiments of a second radio node;

FIG. 6 schematically illustrates a vector with data symbols to be transmitted and a code matrix;

FIG. 7 is a matrix schematically illustrating repeated data symbols;

FIG. 8 is a matrix schematically illustrating encoded data symbols;

FIG. 9 is a matrix schematically illustrating a cyclic prefix added to the encoded data symbols;

FIG. 10 is a vector schematically illustrating the transmitted symbol sequence;

FIG. 11 schematically illustrates a received signal comprising delayed versions of the transmitted symbol sequence;

FIG. 12 schematically illustrates the received samples after removal of a cyclic prefix;

FIG. 13 is a matrix schematically illustrating the stacked received samples;

FIG. 14A shows a matrix and a vector schematically illustrating the result after decoding with a first code word;

FIG. 14B shows a matrix and a vector schematically illustrating the result after decoding with a second code word;

FIG. 14C shows a matrix and a vector schematically illustrating the result after decoding with a third code word;

FIG. 14D shows a matrix and a vector schematically illustrating the result after decoding with a fourth code word;

FIG. 15 shows matrices and vectors schematically illustrating the result after sorting of the decoded sequences; and

FIG. 16 schematically illustrates Maximum Ratio Combining.

### DETAILED DESCRIPTION

According to developments of wireless communications networks improved modulation and equalization methods are needed for improving the performance of the wireless communications network.

An object of embodiments herein is therefore how to provide an improved performance in a wireless communications network.

In embodiments disclosed herein, an orthogonal code is applied, by a transmitter, to symbols of a repeated transmission. By the term “orthogonal code” when used in this disclosure is meant that each code word is orthogonal to all other code words, i.e., that the scalar product between any two code words is zero. Further, different code sequences are applied to different repetitions of the transmission. An affix, e.g. a cyclic prefix, may be added to each repetition and the repetitions are transmitted in sequence. At the receiver side, the code is used when combining the repeated blocks. Different code sequences are used to extract different transmitted symbols. The inter-symbol interference will be resolved in the decoding process and thereby the need for equalization and multi-tap channel estimation is eliminated. From the decoding process one diversity branch for each channel tap in the time-dispersive channel is obtained when assuming that the number of channel taps is not larger than the number of coded repetitions. To combine the diversity branches, a Maximum Ratio Combining (MRC) may be used.

In this disclosure the “channel tap” is sometimes referred to as a “channel coefficient”, and it should be understood that the terms “channel tap” and “channel coefficient” may be used interchangeably.

Note that although terminology from 3GPP LTE is used in this disclosure to exemplify the embodiments herein, this should not be seen as limiting the scope of the embodiments herein to only the aforementioned system. Other wireless systems, such as for example 5G, Wideband Code-Division Multiple Access (WCDMA), Worldwide Interoperability for Microwave Access (WiMax), Ultra-Mobile Broadband (UMB) and GSM, may also benefit from exploiting the ideas covered within this disclosure.

In this section, the embodiments herein will be illustrated in more detail by a number of exemplary embodiments. It should be noted that these embodiments are not mutually exclusive. Components from one embodiment may be assumed to be present in another embodiment and it will be obvious to a person skilled in the art how those components may be used in the other exemplary embodiments.

Further, the description frequently refers to wireless transmissions in the downlink, but embodiments herein are equally applicable in the uplink.

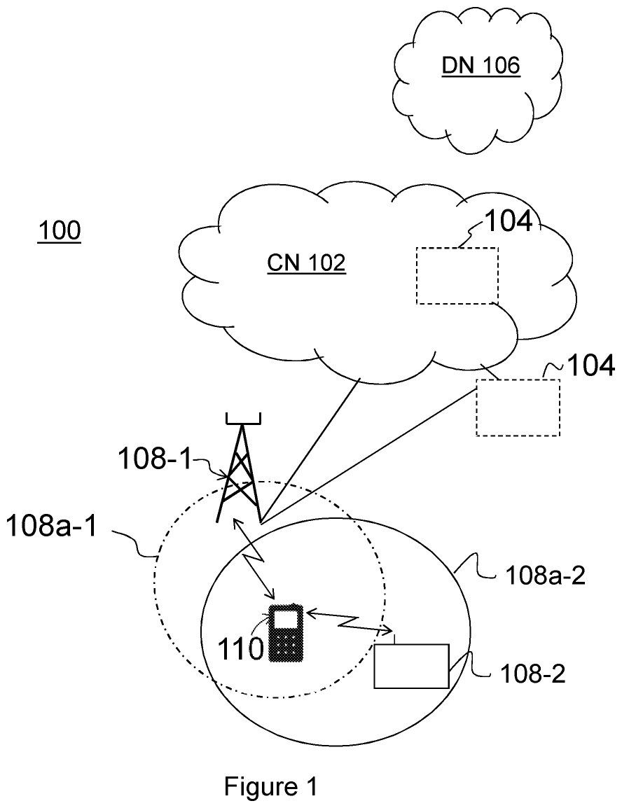

FIG. 1 depicts an example of the wireless communications network 100 in which embodiments herein may be implemented. The wireless communications network 100 is a wireless communication network such as a New radio (NR) network, a 5G network, a GSM EDGE Radio Access Network (GERAN) network, an LTE network, a WCDMA network, a GSM network such as an Extended Coverage (EC) GSM, any 3GPP cellular network, a WiMAX network, a Wireless Local Area Network (WLAN), a Bluetooth communications network such as a Bluetooth Long Range (BLR) communications network, a NB-IoT communications network, or any wireless or cellular network/system.

The wireless communications network 100 may be a wireless communications network providing extended coverage.

Some embodiments disclose modulation and demodulation methods for single carrier modulation wireless communications network operating in extended coverage mode. Thus, the wireless communications network 100 may be a wireless 10 communications network operating in extended coverage mode and applying single carrier modulation.

Some embodiments disclosed herein may be applied to any wireless communications network using single carrier linear or linearizable modulations, such as Gaussian Frequency-Shift Keying (GFSK), Gaussian Minimum Shift Keying (GMSK) or Offset Quadrature Phase-Shift Keying (OQPSK), employed in Bluetooth, DECT, GSM and Zigbee.

Further, it should be understood that some embodiments may be applied in new and emerging fields of wireless communications networks such as in light communications network. Thus, the wireless communications network 100 may be a light communications network.

A core network 102 may be comprised in the wireless communications network 100. The core network 102 is a wireless core network such as a NR core network, a 5G core network, GERAN core network, an LTE core network, e.g. an Evolved Packet Core (EPC); a WCDMA core network; a GSM core network; any 3GPP core network; WiMAX core network; or any wireless or cellular core network.

A core network node 104 may operate in the core network 102. The core network node 104 may be an Evolved Serving Mobile Location Centre (E-SMLC), a Mobile Switching Centre (MSC), a Mobility-Management Entity (MME), an Operation and

Maintenance (O&M) node, a Serving GateWay (S-GW), a Serving General Packet-Radio Service (GPRS) Node (SGSN), etc.

A first radio node 108-1, 108-2; 110 and a second radio node 110; 108-1, 108-2 are operating in the wireless communications network 100. In this disclosure the first radio node 108-1, 108-2; 110 is acting as a transmitter, e.g. as a transmitting node, and the second radio node 110; 108-1, 108-2 is acting as a receiver, e.g. as a receiving node. However, it should be understood that the second radio node may be the transmitter and that the first radio node may be the receiver. Thus, both the first and second radio nodes may be configured with functionality to act as both a transmitter and a receiver. In case the first radio node 108-1, 108-2; 110 is a base station, e.g. an eNB, 108-1 or a WLAN AP 108-2, the second radio node 110; 108-1, 108-2 is a wireless device 110, and vice versa.

The first radio node 108-1, 108-2 may serve the second radio node 110 when located within an area, e.g. a first serving area 108a-1, 108a-2. The first radio node 108-1, 108-2 may be a transmission and reception point e.g. a radio access network node such as a Wireless Local Area Network (WLAN) access point or an Access Point Station (AP STA), an access controller, a base station, e.g. a radio base station such as a NodeB, an evolved Node B (eNB, eNode B), a base transceiver station, a radio remote unit, an Access Point Base Station, a base station router, a transmission arrangement of a radio base station, a stand-alone access point or any other network unit capable of communicating with a wireless device within the service area served by the access point depending e.g. on the first radio access technology and terminology used. The first radio node 108 may be referred to as a serving radio network node and communicates with a wireless device with Downlink (DL) transmissions to the wireless device and Uplink (UL) transmissions from the wireless device. Other examples of the first radio node 108 are Multi-Standard Radio (MSR) nodes such as MSR BS, network controllers, Radio Network Controllers (RNCs), Base Station Controllers (BSCs), relays, donor nodes controlling relay, Base Transceiver Stations (BTSs), Access Points (APs), transmission points, ransmission nodes, Remote Radio Units (RRUs), Remote Radio Heads (RRHs), nodes in Distributed Antenna System (DAS), etc. In case of Device-to-Device communication, the first radio node may be a wireless device.

The second radio node 110 may be a wireless device, such as a mobile station, a non-Access Point (non-AP) STA, a STA, a user equipment (UE) and/or a wireless terminals, communicate via one or more Access Networks (AN), e.g. RAN, to one or more Core Networks (CN).

It should be understood by the skilled in the art that “wireless device” is a non-limiting term which means any terminal, communications device, wireless communication terminal, user equipment, Machine-Type Communication (MTC) device, Device-to-Device (D2D) terminal, or node e.g. smart phone, laptop, mobile phone, sensor, relay, mobile tablets, an Internet-of-Things (IoT) device, e.g. a Cellular IoT (CIoT) device or even a small base station communicating within a service area.

In this disclosure the terms communications device, terminal, wireless device and UE are used interchangeably. Please note the term user equipment used in this document also covers other wireless devices such as Machine-to-Machine (M2M) devices, even though they do not have any user.

Methods e.g. for transmitting a signal comprising encoded data symbols in the 10 wireless communications network 100, is performed by the first radio node 108-1, 108-2; 110. Further, methods e.g. for decoding and extracting data symbols from a signal received from the first radio node 108-1, 108-2; 110 is performed by the second radio node 110;108-1, 108-2. As an alternative, a Distributed Node (DN) and functionality, e.g. comprised in a cloud 106 as shown in FIG. 1 may be used for performing or partly performing the methods.

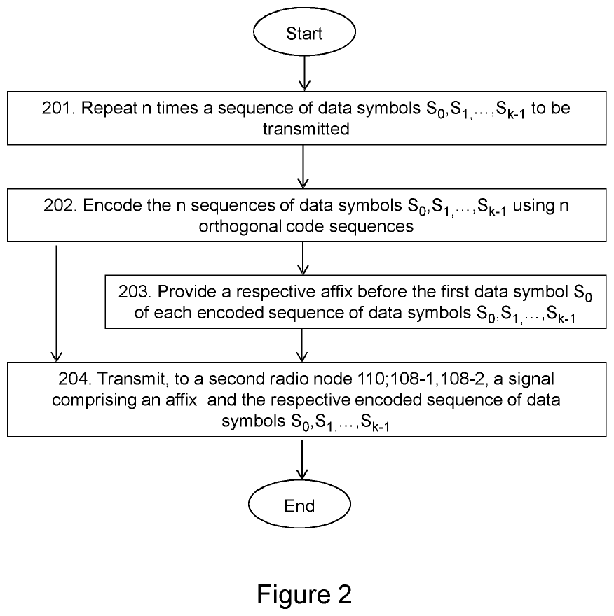

Examples of methods performed by the first radio node 108-1, 108-2; 110 for transmitting a signal comprising encoded data symbols to the second radio node 110; 108-1, 108-2 will now be described with reference to flowchart depicted in FIG. 2. As 20 previously mentioned, the first radio node 108-1, 108-2; 110 and the second radio node 110; 108-1, 108-2 are operating in the wireless communications network 100. Thus, the first radio node 108-1, 108-2; 110 is acting as a transmitter and the second radio node 110; 108-1, 108-2 is acting as a receiver. However, it should be understood that the second radio node may be the transmitter and that the first radio node may be the 25 receiver. In case the first radio node is a base station e.g. an eNB, 108-1 or a WLAN AP 108-2, the second radio node is a wireless device 110, and vice versa.

Action 201 The first radio node 108-1, 108-2; 110 repeats n times a sequence of data symbols So,S1, . . . ,Sk−1 to be transmitted, wherein k is a multiple of n. The repetition is done in order to obtain extended coverage by transmitting the sequence of data symbols So,S1, . . . ,Sk−1 several times, i.e. n times. k should be a multiple of n in order to ensure that the inter-symbol interference from the cyclic prefix is orthogonal to the transmitted sequence of data.

The data symbols S₀,S₁, . . . ,Sₖ₋₁ may be data symbols from a symbol constellation of a linear modulation or a non-linear modulation.

The linear modulation may be a Phase-Shift Keying (PSK), such as Binary PSK (BPSK), Quadrature PSK (QPSK) or 8 PSK, or a Quadrature Amplitude Modulation (QAM) such as 16 QAM, 32 QAM, or 64 QAM, just to give some examples.

The non-linear modulation may be one out of a Gaussian Minimum Shift Keying (GMSK), a Gaussian Frequency-Shift Keying (GFSK), and a Minimum-Shift Keying (MSK), just to give some examples.

In some embodiments, one or more of the data symbols S₀,S₁, . . . ,Sₖ₋₁ are 10 training symbols. For example, this may be the case when a phase/amplitude reference is needed, relative to which the information bearing data symbols are interpreted (demodulated), and thereby coherent demodulation is achieved.

Embodiments described herein may be realized using matrices. In such embodiments, the first radio node 108-1, 108-2; 110, when repeating n times the sequence of data symbols S₀,S₁, . . . ,Sₖ₋₁, generates an n by k matrix, wherein each row is a copy of a sequence of data symbols S₀,S₁, . . . ,Sₖ₋₁, wherein n is the number of repetitions of the sequence of data symbols S₀,S₁, . . . ,Sₖ₋₁.

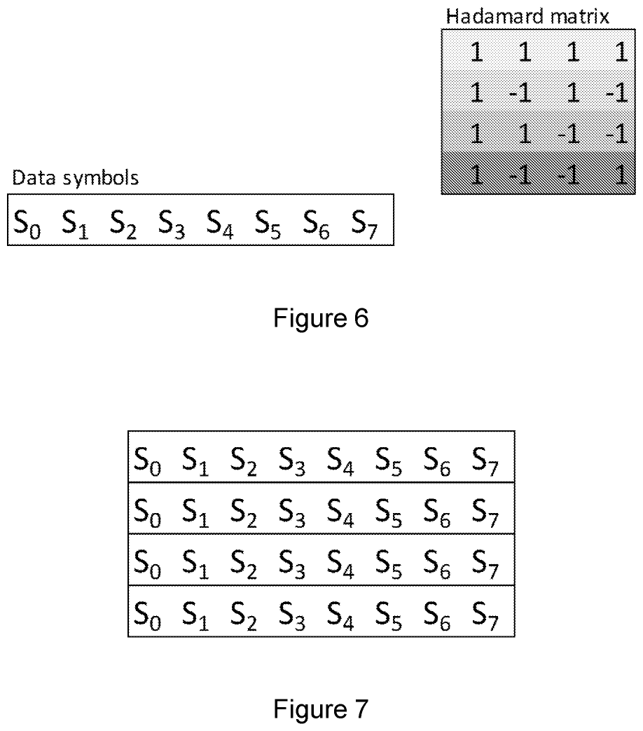

FIG. 6 schematically illustrates a vector with data symbols S₀,S₁, . . . ,S₇, to be transmitted and a code matrix. FIG. 6 will be described in more detail below.

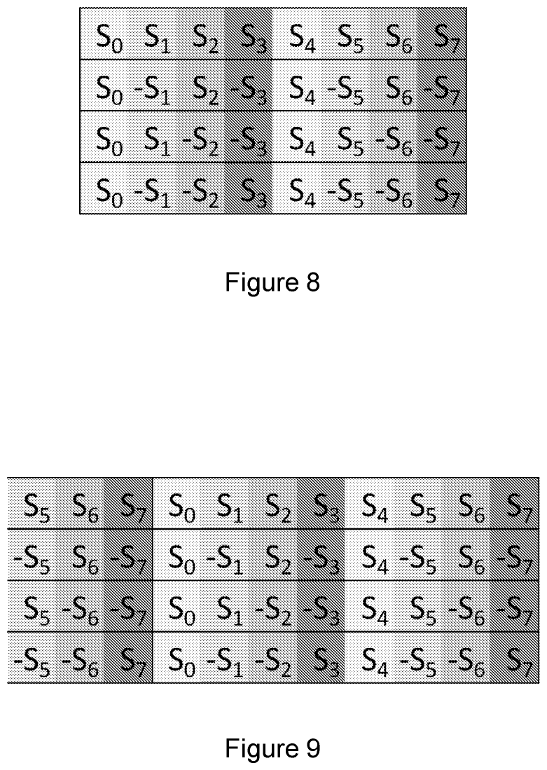

FIG. 7 is a matrix schematically illustrating n=4 times repeated data symbols S₀,S₁, . . . ,S₇. FIG. 7 will be described in more detail below.

### Action 202

The first radio node 108-1, 108-2; 110 encodes the n sequences of data symbols S₀,S₁, . . . ,Sₖ₋₁ using n orthogonal code sequences, wherein each code sequence comprises n code elements.

In some embodiments, the first radio node 108-1, 108-2; 110 encodes the n sequences of data symbols S₀,S₁, . . . ,Sₖ₋₁ by element-wise multiplying one code sequence out of the n orthogonal code sequences to the n times repeated data symbol Sᵢ comprised in the n sequences of data symbols S₀,S₁, . . . ,Sₖ₋₁, wherein i ϵ [0,1, k-1].

In some embodiments, the first radio node 108-1, 108-2; 110 encodes the n sequences of data symbols S₀,S₁, . . . ,Sₖ₋₁ by repeatedly using the n orthogonal code sequences for the encoding of the n sequences of data symbols S₀,S₁, . . . ,Sₖ₋₁, wherein the n orthogonal code sequences are used k/n times each for encoding (each) n times repeated symbol Sᵢ comprised in the n sequences of data symbols S₀,S₁, . . . ,Sₖ₋₁, wherein i ϵ [0,1, . . . , k−1].

The n orthogonal code sequences may comprise real values. In some embodiments, the n orthogonal code sequences are comprised in an n by n Hadamard matrix. Alternatively, the n orthogonal code sequences comprise complex values.

In embodiments realized using the matrices, the the first radio node 108-1, 108-2; 110 encodes then sequences of data symbols S₀,S₁, . . . ,Sₖ₋₁ using n orthogonal code words by encoding the generated n by k matrix by performing element-wise matrix multiplication using a k/n times repeated n by n orthogonal code matrix comprising the n orthogonal code sequences, wherein the encoding results in an encoded n by k matrix.

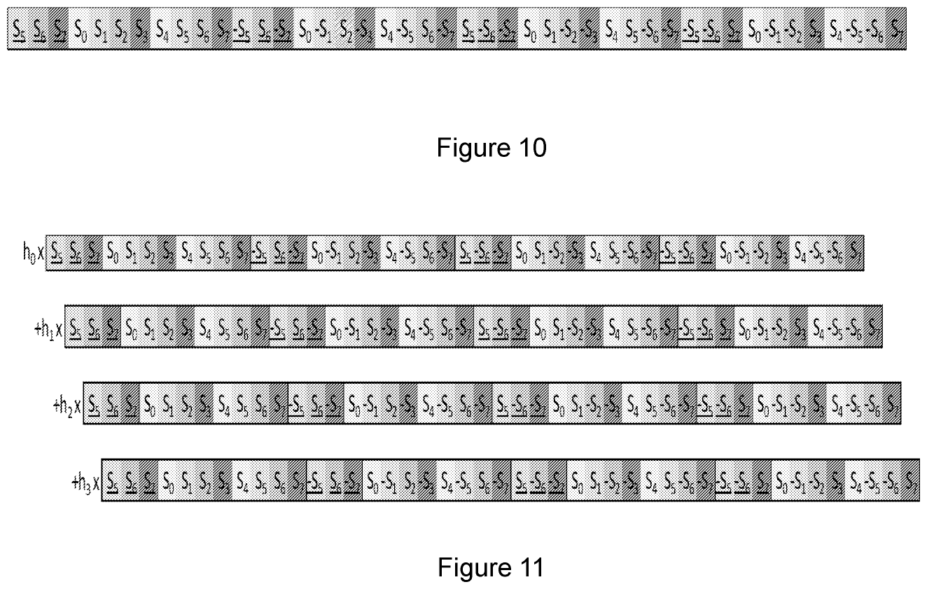

FIG. 8 is a matrix schematically illustrating encoded data symbols. In this example, the data symbols have been encoded using the code matrix of FIG. 6. FIG. 8 will be described in more detail below.

### Action 203

The first radio node 108-1, 108-2; 110 may provide the respective affix before the first data symbol So of each encoded sequence of data symbols S₀,S₁, . . . ,Sₖ₋₁.

In some embodiments, the first radio node 108-1, 108-2; 110 provides the respective affix by inserting a respective cyclic prefix before the first data symbol So of each encoded sequence of data symbols S₀,S₁, . . . ,Sₖ₋₁, wherein the respective cyclic prefix comprises one or more of the last n−1 data symbols of the respective encoded sequence of data symbols S₀,S₁, . . . ,Sₖ₋₁.

In some alternative embodiments, the first radio node 108-1, 108-2; 110 provides the respective affix by providing a respective guard time period before the first data symbol So of each encoded sequence of data symbols S₀,S₁, . . . ,Sₖ₋₁.

In embodiments realized using the matrices, the the first radio node 108-1, 108-2; 110 provides the respective affix by inserting a cyclic prefix before the encoded n by k matrix, which cyclic prefix comprises one or more of the last n−1 columns of the encoded n by k matrix, wherein the inserting results in an n by (x+k) matrix, wherein x is the number of columns of the inserted cyclic prefix. Alternatively, the the first radio node 108-1, 108-2; 110 provides the respective affix by providing a respective guard time period before the first data symbol So of each encoded sequence of data symbols S₀,S₁, . . . ,Sₖ₋₁.

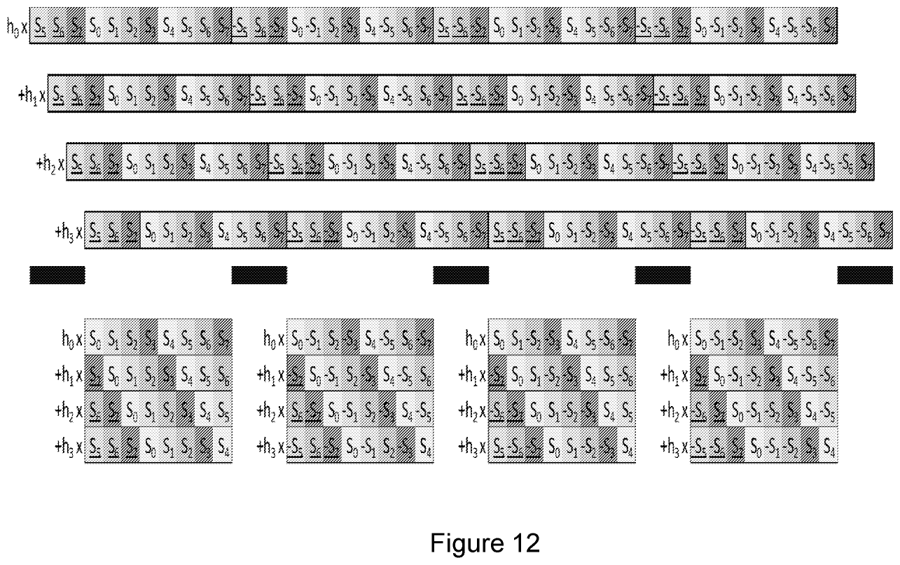

FIG. 9 is a matrix schematically illustrating a cyclic prefix added to the encoded data symbols. In this example, the cyclic prefix corresponds to the last n−1 (n=4)=3 columns of the matrix shown in FIG. 8. FIG. 9 will be described in more detail below.

### Action 204

The first radio node 108-1, 108-2; 110 transmits, to the second radio node 110; 108-1, 108-2, a signal comprising the respective encoded sequence of data symbols S₀,S₁, . . . ,Sₖ₋₁ and an optional respective affix for separating two encoded sequences of data symbols S₀,S₁, . . . ,Sₖ₋₁.

In some alternative embodiments, the first radio node 108-1, 108-2; 110 transmits the respective affix and the respective encoded sequence of data symbols S₀,S₁, . . . ,Sₖ₋₁in sequence using a single carrier. Alternatively, the first radio node 108-1, 108-2; 110 transmits the respective affix and the respective encoded sequence of data symbols S₀,S₁, . . . ,Sₖ₋₁ in parallel using a respective subcarrier in a multicarrier signal.

The first radio node 108-1, 108-2; 110 transmits the respective sequence of data symbols S₀,S₁, . . . ,Sₖ₋₁ by further performing one or more out of: pulse shaping; digital to analog conversion; up-conversion to radio frequency; and power amplification.

In embodiments realized using the matrices, the the first radio node 108-1, 108-2; 110 transmits the respective affix and the respective sequence of data symbols S₀,S₁, . . . ,Sₖ₋₁ by transmitting row wise the respective affix and the data symbols S₀,S₁, . . . ,Sₖ₋₁ comprised in the n by (x+k) matrix.

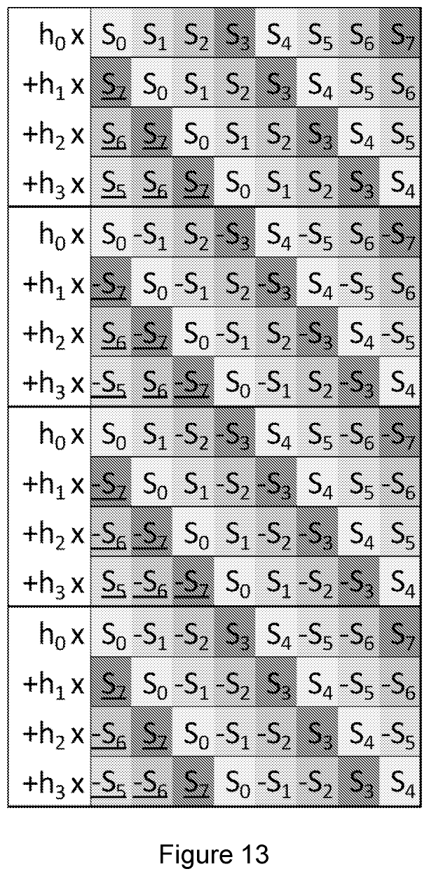

FIG. 10 is a vector schematically illustrating an example of a transmitted symbol sequence. The underlined symbols correspond to symbols of the cyclic prefix. FIG. 10 will be described in more detail below.

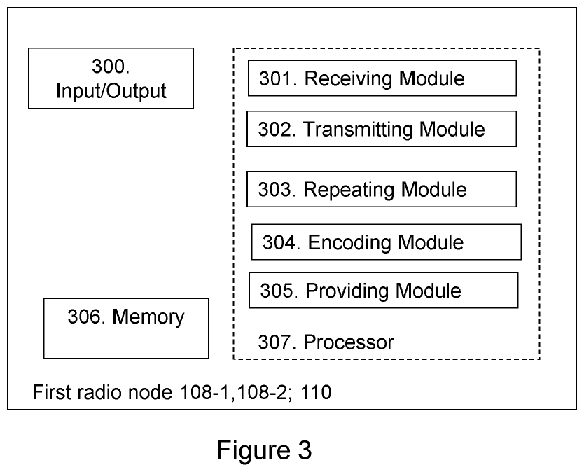

To perform the method for transmitting a signal comprising encoded data symbols to the second radio node 110; 108-1, 108-2, the first radio node 108-1, 108-2; 30 110 may comprise an arrangement depicted in FIG. 3. As previously mentioned, the first radio node 108-1, 108-2; 110 and the second radio node 110; 108-1, 108-2 are configured to operate in the wireless communications network 100. Thus, the first radio node 108-1, 108-2; 110 is acting as a transmitter and the second radio node 110;108-1, 108-2 is acting as a receiver. However, it should be understood that the second radio node may be the transmitter and that the first radio node may be the receiver. In case the first radio node is a base station e.g. an eNB, 108-1 or a WLAN AP 108-2, the second radio node is a wireless device 110, and vice versa.

In some embodiments, the first radio node 108-1, 108-2; 110 via an input and output interface 300 is configured to communicate with one or more second radio node 110; 108-1, 108-2. The input and output interface 300 may comprise a wireless receiver (not shown) and a wireless transmitter (not shown).

The first radio node 108-1, 108-2; 110 is configured to receive, e.g. by means of a receiving module 301 configured to receive, transmissions from one or more second radio nodes 110; 108-1, 108-2. The receiving module 301 may be implemented by or arranged in communication with a processor 307 of the first radio node 108-1, 108-2; 110. The processor 307 will be described in more detail below.

The first radio node 108-1, 108-2; 110 is configured to transmit, e.g. by means of a transmitting module 302 configured to transmit, transmit, to the second radio node 110; 108-1, 108-2, a signal comprising a respective encoded sequence of data symbols S₀,S₁, . . . ,Sₖ₋₁ and an optional respective affix for separating two encoded sequences of data symbols S₀,S₁, . . . ,Sₖ₋₁. The transmitting module 302 may be implemented by or arranged in communication with the processor 307 of the first radio node 108-1, 108-2; 110.

As previously mentioned, the data symbols S₀,S₁, . . . ,Sₖ₋₁ may be data symbols from a symbol constellation of a linear modulation or a non-linear modulation.

The linear modulation may be a PSK, such as BPSK, PSK, a QPSK or an 8PSK, or a QAM such as 16 QAM, 32 QAM, or 64 QAM, just to give some examples.

The non-linear modulation may be one out of a GMSK, a GFSK, and a MSK, just to give some examples.

In some embodiments, one or more of the data symbols S₀,S₁, . . . ,Sₖ₋₁ are training symbols.

In some embodiments, the first radio node 108-1, 108-2; 110 is configured to transmit the signal comprising the respective affix and the respective encoded sequence of data symbols S₀,S₁, . . . ,Sₖ₋₁ by further being configured to transmit the respective affix and the respective encoded sequence of data symbols S₀,S₁, . . . ,Sₖ₋₁ in sequence using a single carrier; or to transmit the respective affix and the respective encoded sequence of data symbols S₀,S₁, . . . ,Sₖ₋₁ in parallel using a respective subcarrier in a multicarrier signal. The first radio node 108-1, 108-2; 110 may further be configured to transmit to the respective sequence of data symbols S₀,S₁, . . . ,Sₖ₋₁ by further being configured to perform one or more out of: pulse shaping; digital to analog conversion; up-conversion to radio frequency; and power amplification.

In embodiments realized using the matrices, the first radio node 108-1, 108-2; 110 is configured to transmit the respective affix and the respective sequence of data symbols S₀,S₁, . . . ,Sₖ₋₁ by being configured to transmit row wise the respective affix and the data symbols S₀,S₁, . . . ,Sₖ₋₁ comprised in the n by (x+k) matrix.

The first radio node 108-1, 108-2; 110 is configured to repeat, e.g. by means of a repeating module 303 configured to repeat, n times a sequence of data symbols S₀,S₁, . . . ,Sₖ₋₁ to be transmitted, wherein k is a multiple of n. The repeating module 303 may be implemented by or arranged in communication with the processor 307 of the first radio node 108-1, 108-2; 110.

In embodiments realized using the matrices, the first radio node 108-1, 108-2; 20 110 is configured to repeat n times of the sequence of data symbols S₀,S₁, . . . ,Sₖ₋₁ by being configured to generate an n by k matrix, wherein each row is a copy of a sequence of data symbols S₀,S₁, . . . ,Sₖ₋₁, wherein n is the number of repetitions of the sequence of data symbols S₀,S₁, . . . ,Sₖ₋₁.

The first radio node 108-1, 108-2; 110 is configured to encode, e.g. by means of an encoding module 304 configured to encode, the n sequences of data symbols S₀,S₁, . . . ,Sₖ₋₁ using n orthogonal code sequences, wherein each code sequence comprises n code elements. The encoding module 304 may be implemented by or arranged in communication with the processor 507 of the first radio node 108-1, 108-2; 30 110.

In some embodiments, the first radio node 108-1, 108-2; 110 is configured to encode the n sequences of data symbols S₀,S₁, . . . ,Sₖ₋₁ by further being configured to element-wise multiply one code sequence out of the n orthogonal code sequences to the n times repeated data symbol Sᵢ comprised in the n sequences of data symbols S₀,S₁, . . . ,Sₖ₋₁, wherein i ϵ [0,1, . . . , k-1].

In some embodiments, the first radio node 108-1, 108-2; 110 is configured to encode the n sequences of data symbols S₀,S₁, . . . ,Sₖ₋₁ by further being configured to repeatedly use the n orthogonal code sequences for the encoding of the n sequences of data symbols S₀,S₁, . . . ,Sₖ₋₁, wherein the n orthogonal code sequences are used k/n times each for encoding (each) n times repeated symbol Sᵢ comprised in the n sequences of data symbols S₀,S₁, . . . ,Sₖ₋₁, wherein i ϵ [0,1, . . . , k−1].

As previously mentioned, the n orthogonal code sequences may comprise real values. In some embodiments, the n orthogonal code sequences are comprised in an n by n Hadamard matrix. Alternatively, the n orthogonal code sequences comprise complex values.

In embodiments realized using the matrices, the first radio node 108-1, 108-2; 110 is configured to encode then sequences of data symbols S₀,S₁, . . . ,Sₖ₋₁ using n orthogonal code words by encoding the generated n by k matrix by performing element-wise matrix multiplication using a k/n times repeated n by n orthogonal code matrix comprising the n orthogonal code sequences, wherein the encoding results in an encoded n by k matrix.

The first radio node 108-1, 108-2; 110 may be configured to provide, e.g. by means of a providing module 305 configured to provide, the respective affix before the first data symbol So of each encoded sequence of data symbols S₀,S₁, . . . ,Sₖ₋₁. The providing module 305 may be implemented by or arranged in communication with the processor 507 of the first radio node 108-1, 108-2; 110.

In some embodiments, the first radio node 108-1, 108-2; 110 is configured to provide the respective affix by further being configured to insert a respective cyclic prefix before the first data symbol So of each encoded sequence of data symbols S₀,S₁, . . . ,Sₖ₋₁, wherein the respective cyclic prefix comprises one or more of the last n−1 data symbols of the respective encoded sequence of data symbols S₀,S₁, . . . ,Sₖ₋₁.

In some alternative embodiments, the first radio node 108-1, 108-2; 110 is configured to provide the respective affix by further being configured to provide a respective guard time period before the first data symbol So of each encoded sequence of data symbols S₀,S₁, . . . ,Sₖ₋₁.

In embodiments realized using the matrices, the first radio node 108-1, 108-2; 110 is configured to provide the respective affix by being configured to insert a cyclic prefix before the encoded n by k matrix, which cyclic prefix comprises one or more of the last n−1 columns of the encoded n by k matrix, wherein the inserting results in an n by (x+k) matrix, wherein x is the number of columns of the inserted cyclic prefix. Alternatively, the first radio node 108-1, 108-2; 110 may be configured to provide the respective affix by being configured to provide a respective guard time period before the first data symbol So of each encoded sequence of data symbols S₀,S₁, . . . ,Sₖ₋₁.

The first radio node 108-1, 108-2; 110 may also comprise means for storing data. In some embodiments, the first radio node 108-1, 108-2; 110 comprises a memory 306 configured to store the data. The data may be processed or non-processed data and/or information relating thereto. The memory 306 may comprise one or more memory units.

Further, the memory 306 may be a computer data storage or a semiconductor memory such as a computer memory, a read-only memory, a volatile memory or a non-volatile memory. The memory is arranged to be used to store obtained information, data, configurations, scheduling decisions, and applications, etc. to perform the methods herein when being executed in the first radio node 108-1, 108-2; 110.

Embodiments herein for transmitting a signal comprising encoded data symbols to the second radio node 110; 108-1, 108-2 may be implemented through one or more processors, such as the processor 307 in the arrangement depicted in FIG. 3, together with computer program code for performing the functions and/or method actions of embodiments herein. The program code mentioned above may also be provided as a computer program product, for instance in the form of a data carrier carrying computer program code for performing the embodiments herein when being loaded into the first radio node 108-1, 108-2; 110. One such carrier may be in the form of an electronic signal, an optical signal, a radio signal or a computer-readable storage medium. The computer-readable storage medium may be a CD ROM disc or a memory stick.

The computer program code may furthermore be provided as program code stored on a server and downloaded to the first radio node 108-1, 108-2; 110.

Those skilled in the art will also appreciate that the input/output interface 300, the receiving module 301, the transmitting module 302, the repeating module 303, and the encoding module 304, and the providing module 305 above may refer to a combination of analog and digital circuits, and/or one or more processors configured with software and/or firmware, e.g. stored in the memory 306, that when executed by the one or more processors such as the processors in the first radio node 108-1, 108-2; 110 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

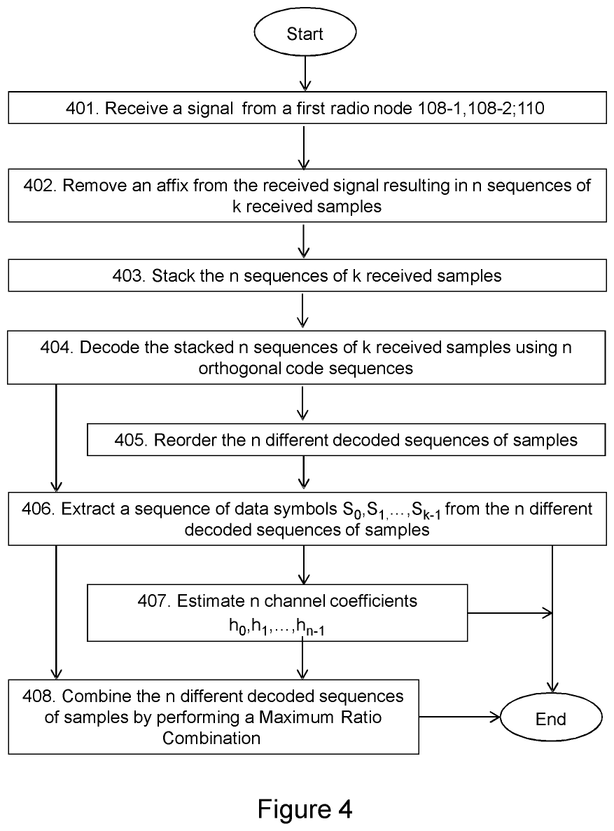

Examples of methods performed by the second radio node 110; 108-1, 108-2 for decoding and extracting data symbols from a signal received from the first radio node 108-1, 108-2; 110 will now be described with reference to flowchart depicted in FIG. 4. As previously mentioned, the first radio node 108-1, 108-2; 110 and the second radio node 110; 108-1, 108-2 are operating in the wireless communications network 100. Thus, the first radio node 108-1, 108-2; 110 is acting as a transmitter and the second radio node 110; 108-1, 108-2 is acting as a receiver. However, it should be understood that the second radio node may be the transmitter and that the first radio node may be the receiver. In case the first radio node is a base station e.g. an eNB, 108-1 or a WLAN AP 108-2, the second radio node is a wireless device 110, and vice versa.

The methods comprise one or more of the following actions. Thus one or more of the actions may be optional. It should be understood that the actions may be taken in any suitable order and that some actions may be combined.

### Action 401

The second radio node 110; 108-1, 108-2 receives a signal from the first radio node 108-1, 108-2; 110. The signal may be a weighted sum of delayed versions of a signal transmitted from the first radio node 108-1, 108-2; 110.

On the received signal, the second radio node 110; 108-1, 108-2 may perform signal processing such as one or more out of: analog filtering, down-conversion to baseband, analog to digital conversion, and digital filtering.

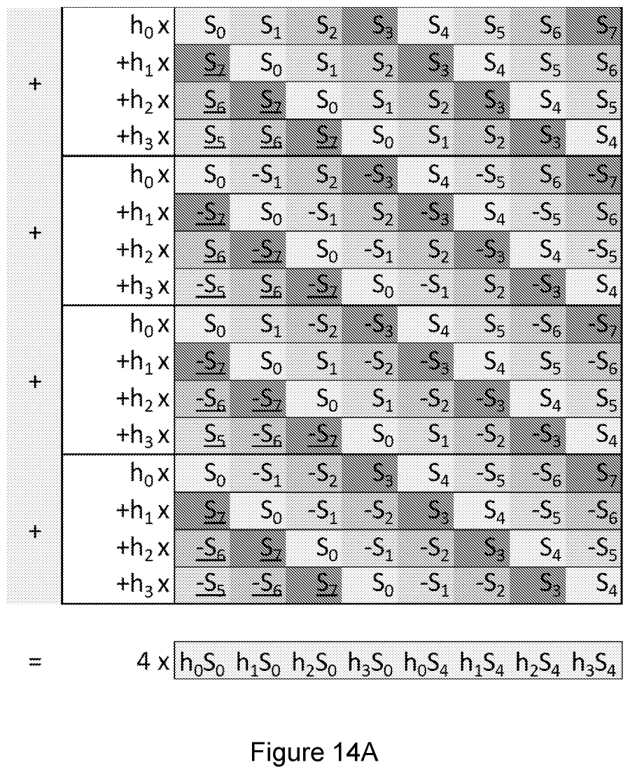

FIG. 11 schematically illustrates an example of a received signal comprising delayed versions of the transmitted symbol sequence. FIG. 11 will be described in more detail below.

### Action 402

The second radio node 110; 108-1, 108-2 removes a possible affix from the received signal resulting in n sequences of k received samples. As previously mentioned, the affix is optional and thus the received signal may not comprise an affix and consequently the second radio node 110; 108-1, 108-2 does not have to remove an affix. If the received signal comprises an affix, the affix is used to separate the sequences of received samples and is not part of the sequences of received samples that should be decoded, and therefore the affix should be removed.

Each received sample is a weighted sum of several data symbols due to ISI plus possible noise and interference.

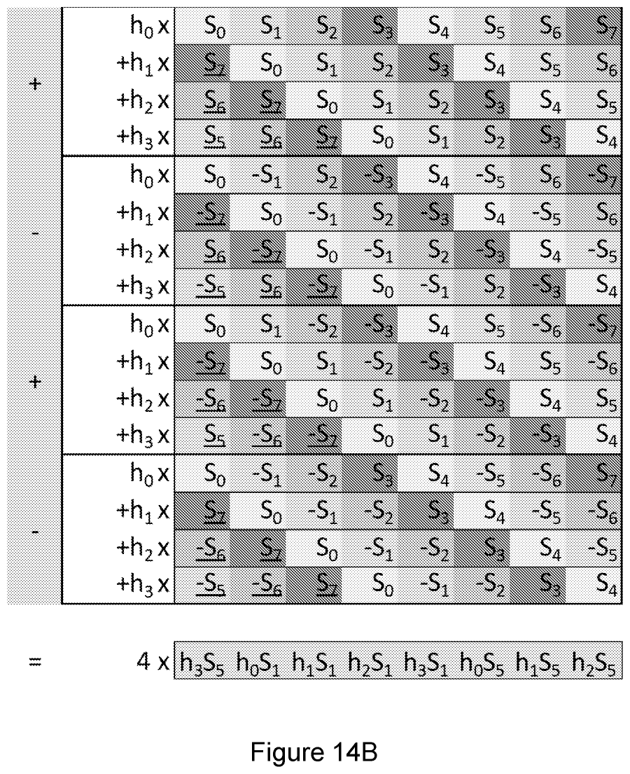

FIG. 12 schematically illustrates an example of the received samples after removal of a cyclic prefix. FIG. 12 will be described in more detail below.

### Action 403

The second radio node 110; 108-1, 108-2 stacks the n sequences of k received samples. The reason for stacking the n sequences of k received samples is to align received samples corresponding to the same transmitted symbols, thereby simplifying subsequent processing performed per symbol position (the subsequent adding which will be described in Action 404 below).

As previously mentioned, embodiments described herein may be realized using matrices. In such embodiments, the second radio node 110; 108-1, 108-2 stacks the n sequences of k received samples by stacking the n sequences of k received samples into a first n by k matrix.

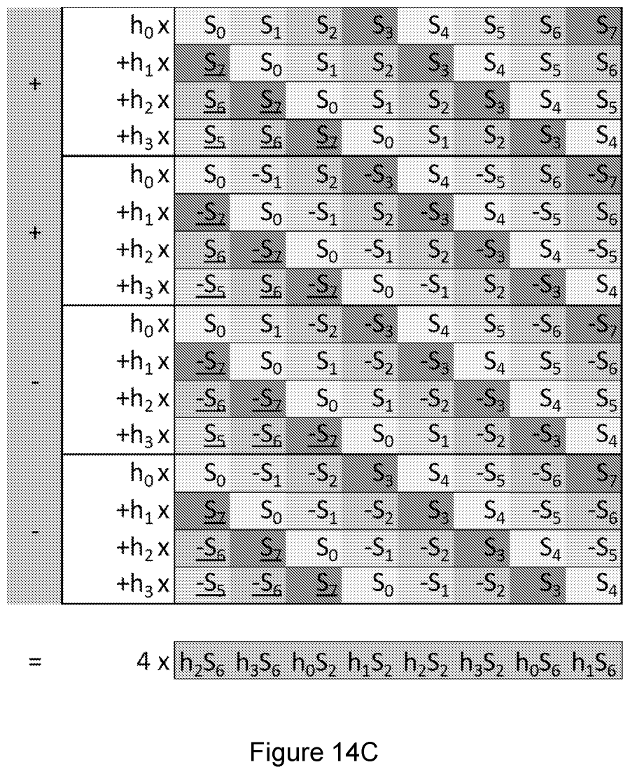

FIG. 13 is a matrix schematically illustrating an example of the stacked received samples. FIG. 13 will be described in more detail below.

### Action 404

The second radio node 110; 108-1, 108-2 decodes the stacked n sequences of k received samples using n orthogonal code sequences, wherein each code sequence comprises n code elements. Further, for each code sequence each of the n sequences of k received samples is multiplied to one out of the n code elements of the code sequence and the multiplied sequences of received samples are subsequently added. Thereby, the decoding results in n different decoded sequences of samples of length k, wherein each decoded sequence of samples corresponds to one of the n applied code sequences.

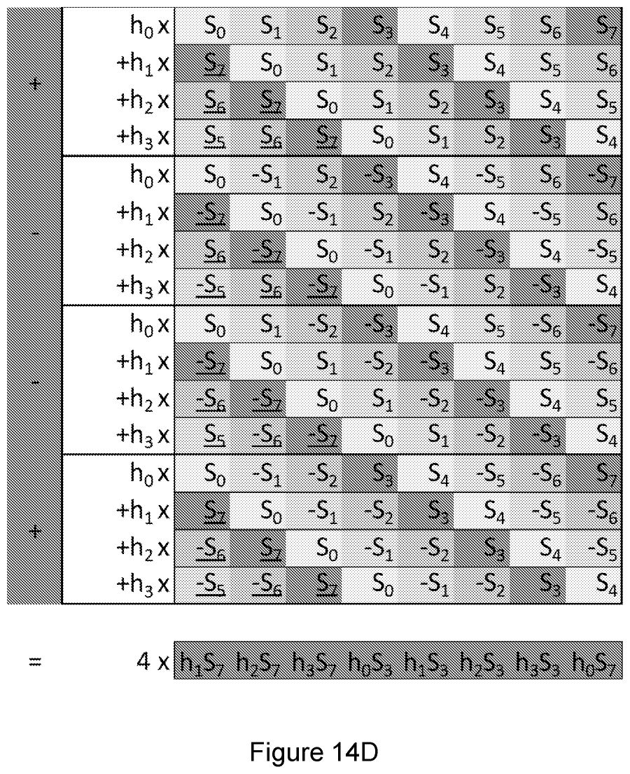

In embodiments realized using the matrices, the second radio node 110; 108-1, 108-2 decodes the stacked sequences of k received samples using n orthogonal code sequences by decoding the first n by k matrix using an n by n orthogonal code matrix comprising the n orthogonal code sequences, wherein each code sequence comprises n code elements. The decoding results in a second n by k matrix. FIGS. 14A-14D shows matrices and vectors schematically illustrating the result after decoding with a first code word, a second code word, a third code word and a fourth code word, respectively. FIGS. 14A-14D will be described in more detail below.

### Action 405

In some embodiments, the second radio node 110; 108-1, 108-2 reorders the n different decoded sequences of samples and possibly moving elements between the n different decoded sequences of samples to obtain n different decoded and reordered sequences of samples.

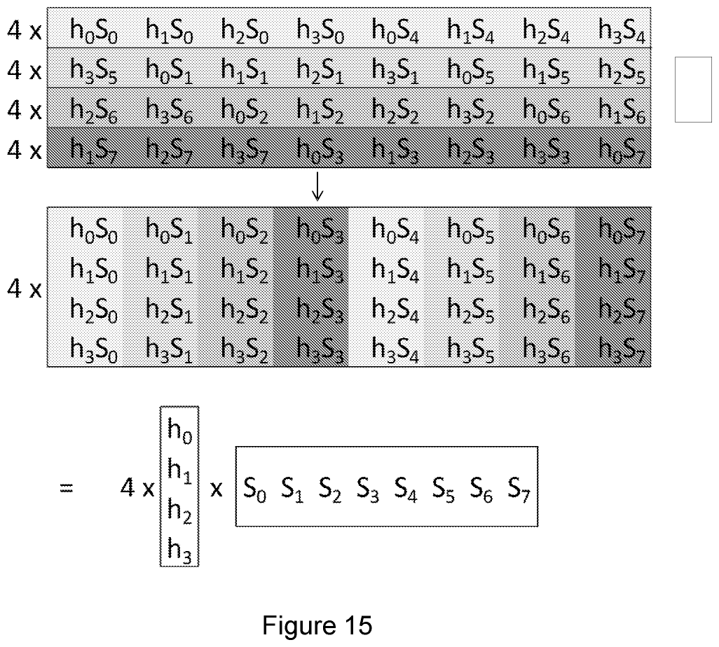

FIG. 15 shows matrices and vectors schematically illustrating the result after sorting of the decoded sequences. FIG. 15 will be described in more detail below.

Action 406 The second radio node 110; 108-1, 108-2 extracts a sequence of data symbols S₀,S₁, . . . ,Sₖ₋₁ from the n different decoded sequences of samples. The extracted sequence of data symbols S₀,S₁, . . . ,Sₖ₋₁ are the same sequence of data symbols as the one that was to be transmitted by the first radio node 108-1, 108-2; 110 in Action 201 above. Thus, the signal received by the second radio node 110; 108-1, 108-2 has been successfully decoded and the correct sequence of data symbols extracted.

In embodiments realized using the matrices, the second radio node 110; 108-1, 108-2 extracts the sequence of data symbols S₀,S₁, . . . ,Sₖ₋₁ from the n different decoded sequences of samples by extracting the sequence of data symbols S₀,S₁, . . . ,Sₖ₋₁ from the second n by k matrix.

### Action 407

In some embodiments, the second radio node 110; 108-1, 108-2 estimates n channel coefficients h₀, h₁, . . . hₙ₋₁, wherein each one of then different decoded sequences of samples corresponds to the sequence of data symbols S₀,S₁, . . . ,Sₖ₋₁ multiplied by a respective channel coefficient.

Each channel coefficient is a complex number corresponding to an amplification and a phase shift for one of the delayed versions of the transmitted symbol sequence (as illustrated in FIG. 11). The channel coefficients may be estimated if one or a few of the data symbols are training symbols. The use of training symbols and their positions would typically be a predetermined part of the used transmission scheme. The alternative to using training symbols would be to use a differential modulation. Differential modulation means that the relative phase (and possibly amplitude) changes between consecutive transmitted symbols is determined by the information bits to be communicated, thereby making an absolute phase/amplitude reference unnecessary.

### Action 408

In some embodiments, the second radio node 110; 108-1, 108-2 combines the n different decoded sequences of samples by performing a Maximum Ratio Combination, MRC, whereby the signal to noise ratio is increased. By the term “signal” when used here is meant the n reordered sequences, i.e. the rows of the matrix in the middle part of FIG. 15. Thus, by performing a MRC the ratio between the signal strength of the n reordered sequences and noise is increased.

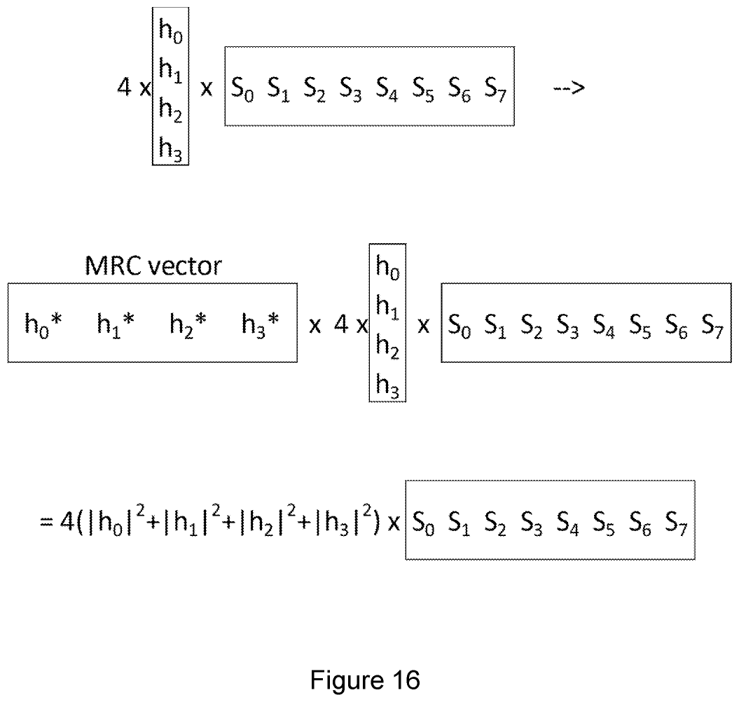

FIG. 16 schematically illustrates Maximum Ratio Combining. FIG. 16 will be described in more detail below.

Actions 407 and 408 described above may in some embodiments be seen as one possible way of performing Action 406 previously described. Thus, the extracting of the sequence of data symbols S₀,S₁, . . . ,Sₖ₋₁ from the n different decoded sequences of samples may be performed by MRC combining the rows of the matrix. However, it should be understood that other possible ways may exist, such as just selecting one row and extracting the symbols from that row (estimating only the channel coefficient corresponding to that row).

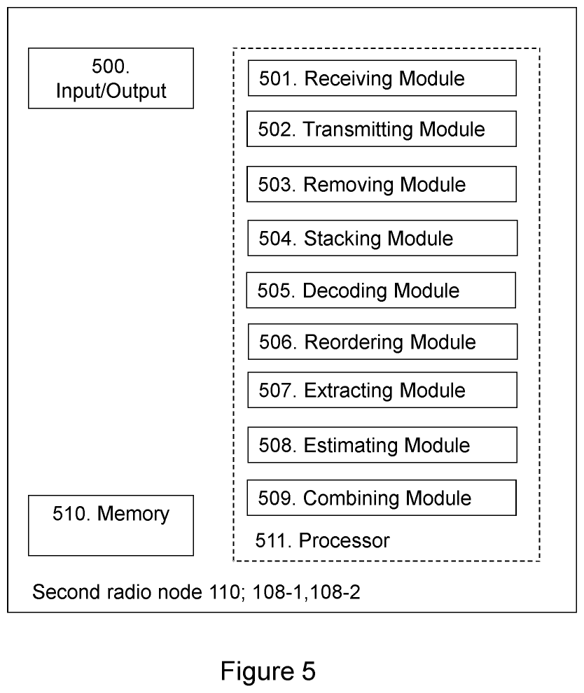

To perform the method for decoding and extracting data symbols from a received signal, the second radio node 110; 108-1, 108-2 may comprise an arrangement depicted in FIG. 5. As previously mentioned, the first radio node 108-1, 108-2; 110 and the second radio node 110; 108-1, 108-2 are configured to operate in the wireless communications network 100. Thus, the first radio node 108-1, 108-2; 110 is acting as a transmitter and the second radio node 110; 108-1, 108-2 is acting as a receiver. However, it should be understood that the second radio node may be the transmitter and that the first radio node may be the receiver. In case the first radio node is a base station e.g. an eNB, 108-1 or a WLAN AP 108-2, the second radio node is a wireless device 110, and vice versa.

In some embodiments, the second radio node 110; 108-1, 108-2 via an input and output interface 500 is configured to communicate with one or more first radio nodes 108-1, 108-2; 110. The input and output interface 500 may comprise a wireless receiver (not shown) and a wireless transmitter (not shown).

The second radio node 110; 108-1, 108-2 is configured to receive, e.g. by means of a receiving module 501 configured to receive, transmissions from the first radio node 108-1, 108-2; 110. The receiving module 501 may be implemented by or arranged in communication with a processor 511 of the second radio node 110; 108-1, 108-2. The processor 511 will be described in more detail below.

The second radio node 110; 108-1, 108-2 is configured to receive a signal from the first radio node 108-1, 108-2; 110. As previously mentioned, the signal may be a weighted sum of delayed versions of a signal transmitted from the first radio node 108-1,108-2; 110.

The second radio node 110; 108-1, 108-2 may be configured to receive the signal by further being configured to perform signal processing such as one or more out of analog filtering, down-conversion to baseband, analog to digital conversion, and digital filtering.

The second radio node 110; 108-1, 108-2 is configured to transmit, e.g. by means of a transmitting module 502 configured to transmit, a transmission to the first radio node 108-1, 108-2; 110. The transmitting module 502 may be implemented by or arranged in communication with the processor 511 of the second radio node 110; 108-1, 108-2.

The second radio node 110; 108-1, 108-2 is configured to remove, e.g. by means of a removing module 503 configured to remove, a possible affix from the received signal resulting in n sequences of k received samples. The removing module 503 may be implemented by or arranged in communication with the processor 511 of the second radio node 110; 108-1, 108-2.

As previously mentioned, each received sample is a weighted sum of several data symbols (due to ISI) plus possible noise and interference.

The second radio node 110; 108-1, 108-2 is configured to stack, e.g. by means of a stacking module 504 configured to stack, the n sequences of k received samples;. The stacking module 504 may be implemented by or arranged in communication with the processor 511 of the second radio node 110; 108-1, 108-2.

Embodiments described herein may be realized using matrices. In such embodiments, the second radio node 110; 108-1, 108-2 is configured to to stack the n sequences of k received samples by being configured to stack the n sequences of k received samples into a first n by k matrix.

The second radio node 110; 108-1, 108-2 is configured to decode, e.g. by means of a decoding module 505 configured to decode, sequences of received samples. The decoding module 505 may be implemented by or arranged in communication with the processor 511 of the second radio node 110; 108-1, 108-2.

The second radio node 110; 108-1, 108-2 is configured to decode the stacked n sequences of k received samples using n orthogonal code sequences, wherein each code sequence comprises n code elements. Further, for each code sequence each of the n sequences of k received samples is multiplied to one out of the n code elements of the code sequence. The multiplied sequences of received samples are subsequently added, and the decoding results in n different decoded sequences of samples of length k each decoded sample corresponding to one of the n applied code sequences.

In embodiments realized using the matrices, the second radio node 110; 108-1, 108-2 is configured to decode the stacked sequences of k received samples using n orthogonal code sequences by being configured to decode the first n by k matrix using an n by n orthogonal code matrix comprising the n orthogonal code sequences, wherein each code sequence comprises n code elements. The decoding results in a second n by k matrix.

The second radio node 110; 108-1, 108-2 may be configured to reorder, e.g. by means of a reordering module 506 configured to reorder, decoded sequences of samples. The reordering module 506 may be implemented by or arranged in communication with the processor 511 of the second radio node 110; 108-1, 108-2.

The second radio node 110; 108-1, 108-2 may be configured to reorder the n different decoded sequences of samples and possibly moving elements between the n different decoded sequences of samples to obtain n different decoded and reordered sequences of samples.

The second radio node 110; 108-1, 108-2 is configured to extract, e.g. by means of an extracting module 507 configured to extract, a sequence of data symbols. The extracting module 507 may be implemented by or arranged in communication with the processor 511 of the second radio node 110; 108-1, 108-2.

The second radio node 110; 108-1, 108-2 is configured to extract a sequence of data symbols S₀,S₁, . . . ,Sₖ₋₁ from the n different decoded sequences of samples.

In embodiments realized using the matrices, the second radio node 110; 108-1, 108-2 is configured to extract the sequence of data symbols S₀,S₁, . . . ,Sₖ₋₁ from the n different decoded sequences of samples by being configured to extract the sequence of data symbols S₀,S₁, . . . ,Sₖ₋₁ from the second n by k matrix.

The second radio node 110; 108-1, 108-2 may be configured to estimate, e.g. by means of an estimating module 508 configured to estimate, one or more channel coefficients. The estimating module 508 may be implemented by or arranged in communication with the processor 511 of the second radio node 110; 108-1, 108-2.

The second radio node 110; 108-1, 108-2 may be configured to estimate n channel coefficients , wherein each one of then different decoded sequences of samples corresponds to the sequence of data symbols S₀,S₁, . . . ,Sₖ₋₁ multiplied by a respective channel coefficient.

As previously mentioned, each channel coefficient is a complex number corresponding to an amplification and a phase shift for one of the delayed versions of the transmitted symbol sequence (as illustrated in FIG. 11). The channel coefficients may be estimated if one or a few of the data symbols are training symbols. The use of training symbols and their positions would typically be a predetermined part of the used transmission scheme. As mentioned above, an alternative to using training symbols would be to use a differential modulation.

The second radio node 110; 108-1, 108-2 may be configured to combine, e.g. by means of a combining module 509 configured to combine, decoded sequences of samples. The combining module 509 may be implemented by or arranged in communication with the processor 511 of the second radio node 110; 108-1, 108-2.

The second radio node 110; 108-1, 108-2 may be configured to combine the n different decoded sequences of samples by performing a Maximum Ratio Combination, MRC, whereby the signal to noise ratio is increased.

The second radio node 110; 108-1, 108-2 may also comprise means for storing data. In some embodiments, the second radio node 110; 108-1, 108-2 comprises a memory 510 configured to store the data. The data may be processed or non-processed data and/or information relating thereto. The memory 510 may comprise one or more memory units. Further, the memory 510 may be a computer data storage or a semiconductor memory such as a computer memory, a read-only memory, a volatile memory or a non-volatile memory. The memory is arranged to be used to store obtained information, data, configurations, scheduling decisions, and applications, etc. to perform the methods herein when being executed in the second radio node 110; 108-1, 108-2.

Embodiments herein for decoding and extracting data symbols from a received signal may be implemented through one or more processors, such as the processor 511 in the arrangement depicted in FIG. 5, together with computer program code for performing the functions and/or method actions of embodiments herein. The program code mentioned above may also be provided as a computer program product, for instance in the form of a data carrier carrying computer program code for performing the embodiments herein when being loaded into the second radio node 110; 108-1, 108-2. One such carrier may be in the form of an electronic signal, an optical signal, a radio signal or a computer-readable storage medium. The computer-readable storage medium may be a CD ROM disc or a memory stick.

The computer program code may furthermore be provided as program code stored on a server and downloaded to the second radio node 110; 108-1, 108-2.

Those skilled in the art will also appreciate that the input/output interface 500, the receiving module 501, the transmitting module 502, the removing module 503, the stacking module 504, the decoding module 505, the reordering module 506, the extracting module 507, the estimating module 508, and the combining module 509 above may refer to a combination of analog and digital circuits, and/or one or more processors configured with software and/or firmware, e.g. stored in the memory 510, that when executed by the one or more processors such as the processors in the second radio node 110; 108-1, 108-2 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

### EXAMPLIFYING EMBODIMENT

In this section a step-by-step description of one embodiment of the coded repetition scheme is described and illustrated.

### Introduction

A sequence of data symbols to be transmitted is illustrated in FIG. 6. Also, a code matrix is given in FIG. 6. In FIG. 6 the grey shades are used to illustrate the four code words, e.g. rows, of the code matrix. In the example, the code matrix is a 4×4 Hadamard matrix, but any n by n orthogonal real- or complex valued code may be used.

The size n of the code matrix shall be equal to the number of coded repetitions to be transmitted. The code words (rows) of the code matrix have been given different grey shades for illustrative purposes The number of data symbols is arbitrarily chosen to be k=8 but may be any multiple of n. The data symbols may be taken from the symbol constellation of any linear modulation. Non-linear modulations such as GFSK and GMSK may also be used but the description below assumes a linear modulation for simplicity. Non-linear modulations will be discussed in more detail below. Some of the data symbols may be training symbols.

One or more actions relating to repetition, encoding, cyclic prefix, and transmission mentioned below are performed by the first radio node 108-1, 108-2; 110 acting as a transmitter.

### Repetition The data symbols are repeated n=4 times. This is illustrated as four rows in the matrix of FIG. 7.

This relates to Action 201 previously described.

### Encoding

The Hadamard code matrix of FIG. 6 is applied symbol-wise, repeatedly. Each column, i.e. repeated symbol, in the matrix is multiplied (element-wise) by a code word, e.g. a row, of the code matrix. The grey shades in FIG. 8 schematically illustrate the code words used for each column.

This relates to Action 202 previously described.

Cyclic prefix

As previously mentioned an optional affix may be added to separate two encoded sequences of data symbols S₀,S₁, . . . ,Sₖ₋₁. In this example, a cyclic prefix is added. The last n−1 columns of the matrix in FIG. 8 are added before the matrix, as schematically illustrated in FIG. 9. Since n=4 in this example, the three last columns of the matrix in FIG. 9 is added.

This relates to Action 203 previously described.

### Transmission

The symbols are transmitted sequentially, row by row in the matrix, as schematically illustrated in FIG. 10. The transmission may involve pulse shaping and one or more other regular transmitter functions.

This relates to Action 204 previously described.

One or more actions relating to reception, encoding, cyclic prefix removal, stacking, decoding, sorting and MRC mentioned below are performed by the second radio node 110; 108-1, 108-2 acting as a receiver.

### Reception

As previously mentioned, due to inter-symbol interference in filters, e.g. in the transmitter filter and/or in the receiver filter, and due to inter-symbol interference in the channel, the received signal will be a weighted sum of delayed versions of the signal, as schematically illustrated in FIG. 11. The weights are the complex valued channel taps hᵢ. Here it is assumed that the total channel length is n. In addition, there will be noise added (not illustrated).

This relates to Action 501 previously described.

### Cyclic Prefix Removal

The cyclic prefix is removed and n sequences of received samples are extracted.

The blocks in the lower end of FIG. 12 schematically illustrate n=4 sequences of k=8 samples each. As mentioned above, each sample is a sum of delayed versions of the signal due to ISI.

This relates to Action 502 previously described.

### Stacking

The n sequences of k received samples are stacked into a matrix. This is schematically illustrated in FIG. 13, which figure illustrates a 4×8 matrix.

This relates to Action 503 previously described.

### Decoding

The code words are applied row-wise and the rows are added. FIG. 14A schematically illustrates the result when the first code word +1,+1,+1,+1 has been applied. The rows are multiplied by +1, +1, +1, +1, respectively, and added. The sum is shown in the lower part of FIG. 14A. Only symbols originally coded with the first code word are present while others have been cancelled. Note that the ISI is removed or rather resolved, since each ISI tap of the channel is represented by a different sample.

Similarly, the second, third and fourth code words are applied to extract the remaining data symbols, as illustrated in FIGS. 14B-14D.

This relates to Action 504 previously described.

### Sorting

The n=4 different decoded sequences illustrated on the upper part in FIG. 15 are sorted into a matrix as shown in the middle part of FIG. 14. The n=4 times repeated signal transmitted over a channel with ISI of four symbols has been transformed into n=4 ISI-free signals as schematically illustrated in the lower part of FIG. 15, each with n=4 times processing gain.

This relates to Action 505 previously described.

### Extracting

The data symbols S₀,S₁, . . . ,S₇ is extracted from the ISI-free signal schematically illustrated in the lower part of FIG. 15.

This relates to Action 506 previously described.

### Maximum Ratio Combining (MRC)

In presence of Additive White Gaussian Noise (AWGN), the SNR of the combined signal is maximized if the n signals are combined using the MRC. This means that the signals should be coherently combined after each have been scaled with the square root of the SNR of the individual signal. Since the noise energy is the same in all n signals, this is equivalent to multiplication by the conjugate of the channel coefficient hᵢ of each signal. This is schematically illustrated in FIG. 16. Channel coefficients may be estimated if one or a few of the data symbols are training symbols. Since the ISI has been removed, the channel estimation is straightforward.

This relates to Actions 507 and 508 previously described.

### Other Aspects

The scheme is applicable for any linear modulation, such as BPSK, 8 PSK, 16 QAM, etc. Since differentially encoded GMSK, GFSK, or MSK, may be approximately or exactly described as a linear modulation, the scheme may be applied to these modulations as well. Multiplications with the code (+1, −1) is then replaced by XORing of bits. It is straightforward to add Rx antenna diversity to the scheme. The Rx branches are processed separately in the receiver and combined using MRC. The MRC between Rx branches is done in the same way as the MRC between diversity branches created by the coded repetition scheme. Coded repetition may be combined with conventional blind transmissions and I/Q combining.

### Exemplifying Formal Description of Some Embodiments

Below, the following notation is used:

a^{T} denotes the transpose of vector (or matrix) a.

a^{H} denotes the conjugate transpose of vector (or matrix) a.

a* denotes the (element-wise) conjugate of vector (or matrix) a.

### Actions of the First Radio Node 108-1, 108-2; 110, e.g. the Transmitter

Given k data symbols [symbol] =[s₀ . . . sₖ₋₁], and an n×n code matrix

$$C = [ {\vec{c}}_{0}^{T} … {\vec{c}}_{n - 1}^{T} ] = [ \begin{matrix}{c}_{0 , 0} & … & {c}_{0 , n - 1} \\ ⋮ & ⋱ & ⋮ \\ {c}_{n - 1 , 0} & … & {c}_{n - 1 , n - 1}\end{matrix} ]$$

with orthogonal columns, where k is an integer multiple of n, the transmitter performs the following steps:

Generate an n×k matrix R in which each row is a copy of

[symbol]

$$R = [ \begin{matrix}{r}_{0 , 0} & … & {r}_{0 , k - 1} \\ ⋮ & ⋱ & ⋮ \\ {r}_{n - 1 , 0} & … & {r}_{n - 1 , k - 1}\end{matrix} ] = [ \begin{matrix}{s}_{0} & … & {s}_{k - 1} \\ ⋮ & ⋮ & ⋮ \\ {s}_{0} & … & {s}_{k - 1}\end{matrix} ]$$

This relates to Action 201 previously described.

### Encoding

Generate an n×k matrix

$$E = [ \begin{matrix}{\vec{e}}_{0} \\ ⋮ \\ {\vec{e}}_{n - 1}\end{matrix} ] = [ \begin{matrix}{e}_{0 , 0} & … & {e}_{0 , k - 1} \\ ⋮ & ⋱ & ⋮ \\ {e}_{n - 1 , 0} & … & {e}_{n - 1 , k - 1}\end{matrix} ]$$

where e_{i,j}=r_{i,j}c_{i,j mod n}, i.e., R is multiplied element-wise with a repeated version of the code matrix C. E can also be written as

E=

[[s₀ [symbol] ₀^{T}] . . . sₙ₋₁ [symbol] ₙ₋₁^{T] [s}ₙ [symbol] ₀^{T} . . . s₂ₙ₋₁ [symbol] ₙ₋₁^{T}] . . . [sₖ₋ₙ [symbol] ₀^{T} . . . [sₖ₋₁ [symbol] ₙ₋₁^{T}]].

This relates to Action 202 previously described.

Cyclic prefix: Generate an n×(k+n−1) matrix

$$P = [ \begin{matrix}{e}_{0 , k - n + 1} & … & {e}_{0 , k - 1} \\ ⋮ & ⋱ & ⋮ \\ {e}_{n - 1 , k - n + 1} & … & {e}_{n - 1 , k - 1}\end{matrix} \vert \begin{matrix}{e}_{0 , 0} & … & {e}_{0 , k - 1} \\ ⋮ & ⋱ & ⋮ \\ {e}_{n - 1 , 0} & … & {e}_{n - 1 , k - 1}\end{matrix} ]$$

I.e., the n−1 last columns of E are concatenated with E.

This relates to Action 203 previously described.

### Transmission

Transmit the symbols of P row-wise, as a sequence [symbol] of n(k+n−1) symbols, using regular transmitter functions (pulse shaping, digital to analog conversion, up-conversion to radio frequency, power amplification, etc.)

This relates to Action 204 previously described.

### Actions of the Second Radio Node 110; 108-1, 108-2, e.g. the Receiver

### Reception

After regular receiver functions (analog filtering, down-conversion to baseband, analog to digital conversion, digital filtering, etc.), the received signal is represented by n(k+n)−1 symbol-spaced complex samples [symbol] =[v₀ . . . vₙ₍ₖ₊ₙ₎₋₂]. Here it is assumed that the combined effect of filtering in the transmitter, time dispersion on the channel and filtering in the receiver can be expressed as [symbol] = [symbol] * [symbol] + [symbol] , where [symbol] =[h₀, . . . hₙ₋₁] are the channel taps and n is a vector with noise samples.

This relates to Action 501 previously described.

Stacking (including removal of possible cyclic prefix)

Stack subsequences of [symbol] into an n×k matrix

$$F = [ \begin{matrix}{\vec{f}}_{0} \\ ⋮ \\ {\vec{f}}_{n - 1}\end{matrix} ] = [ \begin{matrix}{f}_{0 , 0} & … & {f}_{0 , k - 1} \\ ⋮ & ⋱ & ⋮ \\ {f}_{n - 1 , 0} & … & {f}_{n - 1 , k - 1}\end{matrix} ] = [ \begin{matrix}{v}_{n - 1} & … & {v}_{n + k - 2} \\ {v}_{2 ( n - 1 ) + k} & … & {v}_{2 ( n + k ) - 3} \\ ⋮ & ⋱ & ⋮ \\ {v}_{n ( n - 1 ) + ( n - 1 ) k} & … & {v}_{n ( n + k ) - n - 1}\end{matrix} ]$$

I.e., n sequences of k samples are put in the rows of F, skipping the n−1 first samples, the n−1 last samples and n−1 samples between every stored subsequence of [symbol] . Note that due to the cyclic prefix, F= [symbol] *E+N, where [symbol] is the channel, E are the encoded symbols, N is a matrix of AWGN samples with variance σ² and * denotes row-wise cyclic convolution.

This relates to Actions 502 and 503 previously described.

### Decoding

Multiply F with the transpose of the code matrix C from left, giving the n×k matrix

$$D = {C}^{T} F = {C}^{T} ( \vec{h} * E + N ) = {C}^{T} ( \vec{h} * [ [ {s}_{0} {\vec{c}}_{0}^{T} … {s}_{n - 1} {\vec{c}}_{n - 1}^{T} ] [ {s}_{n} {\vec{c}}_{0}^{T} … {s}_{2 n - 1} {\vec{c}}_{n - 1}^{T} ] … [ {s}_{k - n} {\vec{c}}_{0}^{T} … {s}_{k - 1} {\vec{c}}_{n - 1}^{T} ] ] ) + {C}^{T} N = \vec{h} * [ {C}^{T} [ {s}_{0} {\vec{c}}_{0}^{T} … {s}_{n - 1} {\vec{c}}_{n - 1}^{T} ] {C}^{T} [ {s}_{n} {\vec{c}}_{0}^{T} … {s}_{2 n - 1} {\vec{c}}_{n - 1}^{T} ] … {C}^{T} [ {s}_{k - n} {\vec{c}}_{0}^{T} … {s}_{k - 1} {\vec{c}}_{n - 1}^{T} ] ] + {C}^{T} N = n \vec{h} * [ [ \begin{matrix}{s}_{0} & & \\ & ⋱ & \\ & & {s}_{n - 1}\end{matrix} ] [ \begin{matrix}{s}_{n} & & \\ & ⋱ & \\ & & {s}_{2 n - 1}\end{matrix} ] … [ \begin{matrix}{s}_{k - n} & & \\ & ⋱ & \\ & & {s}_{k - 1}\end{matrix} ] ] + {C}^{T} N = n [ \begin{matrix}[ {h}_{0} {s}_{0} & … & {h}_{n - 1} {s}_{0} ] & [ {h}_{0} {s}_{n} & … & {h}_{n - 1} {s}_{n} ] & … & [ {h}_{0} {s}_{k - n} & … & {h}_{n - 1} {s}_{k - n} ] \\ {h}_{n - 1} {s}_{k - n + 1} ] & [ {h}_{0} {s}_{1} & … & {h}_{n - 1} {s}_{1} ] & [ {h}_{0} {s}_{n + 1} & … & {h}_{n - 1} {s}_{n + 1} ] & … & [ {h}_{0} {s}_{k - n + 1} & … \\ ⋮ & ⋮ & ⋮ & ⋮ & ⋮ & ⋮ & ⋮ & ⋮ & ⋮ & ⋮ \\ … & {h}_{n - 1} {s}_{k - 1} ] & [ {h}_{0} {s}_{n - 1} & … & {h}_{n - 1} {s}_{n - 1} ] & [ {h}_{0} {s}_{2 n - 1} & … & {h}_{n - 1} {s}_{2 n - 1} ] & … & [ {h}_{0} {s}_{k - 1}\end{matrix} ] + {N}^{′}$$

where N′ is a matrix of AWGN samples with variance noσ².

This relates to Action 504 previously described.

### Reordering

Generate a n×k matrix X by reordering the elements in D

$$X = n [ \begin{matrix}{h}_{0} {s}_{0} & … & {h}_{0} {s}_{k - 1} \\ ⋮ & ⋱ & ⋮ \\ {h}_{n - 1} {s}_{0} & … & {h}_{n - 1} {s}_{k - 1}\end{matrix} ] + {N}^{″} = n {\vec{h}}^{T} \vec{s} + {N}^{″}$$

where N″ is the reordered version of N′.

It can be noted that the signal received on the time dispersive channel has been separated into n ISI-free signals (represented by the rows in X).

Thereafter, the sequence of data symbols may be extracted. One possible way of doing the extraction is explained by the “MRC combining” action, which requires the channel coefficients from a “Channel estimation” action.

This relates to Actions 505 and 506 previously described.

### Channel Estimation

Estimate the channel vector [symbol] . Since each channel tap impacts only one of the n signals, the channel estimation is straightforward. Using the weights [symbol] * implies that the n signals will be coherently combined, i.e., they are added constructively. Further, the magnitude of the weights will maximize the SNR of the combined signal. The channel coefficients can be estimated if one or a few of the data symbols [symbol] are training symbols.

This relates to Action 507 previously described.

MRC combining

Calculate

[symbol]

= [symbol] X=n [symbol] * [symbol] ^{T} [symbol] + [symbol] *N″=n| [symbol] |² [symbol] +

[symbol]

where [symbol] is a vector of AWGN samples with variance n| [symbol] |²σ². Note that the derived signal is the vector of transmitted symbols [symbol] , plus noise. Assuming that [symbol] has unit energy, the signal-to-noise ratio is

$$\frac{n {‖ \vec{h} ‖}^{2}}{{σ}^{2}} ,$$

i.e., n times the signal-to-noise ratio of the received signal. A processing gain of n times has been achieved.

This relates to Action 508 previously described.

### ABBREVIATIONS

AWGN Additive White Gaussian Noise
ISI Inter-Symbol Interference
MRC Maximum Ratio Combining
SNR Signal to Noise Ratio

When using the word “comprise” or “comprising” it shall be interpreted as non-limiting, i.e. meaning “consist at least of”.

Modifications and other variants of the described embodiment(s) will come to mind to one skilled in the art having the benefit of teachings presented in the foregoing descriptions and the associated drawings. Therefore, it is to be understood that the embodiment(s) herein is/are not be limited to the specific examples disclosed and that modifications and other variants are intended to be included within the scope of this disclosure. Although specific terms may be employed herein, they are used in a generic and descriptive sense only and not for purposes of limitation.

1-42 (canceled).

43. A method performed by a first radio node for transmitting a signal comprising encoded data symbols to a second radio node, wherein the first radio node and the second radio node are operating in a wireless communications network, and wherein the method comprises:
repeating n times a sequence of data symbols S₀, S₁, . . . , Sₖ₋₁ to be transmitted, wherein k is a multiple of n;
encoding the n sequences of data symbols S₀, S₁, . . . , Sₖ₋₁ using n orthogonal code sequences, wherein each code sequence comprises n code elements; and
transmitting, to the second radio node, a signal comprising the respective encoded sequence of data symbols S₀, S₁, . . . , Sₖ₋₁ and an optional respective affix for separating two encoded sequences of data symbols S₀, S₁, . . . , Sₖ₋₁.

44. A method performed by a second radio node for decoding and extracting data symbols from a signal received from a first radio node, wherein the second radio node and the first radio node are operating in a wireless communications network, and wherein the method comprises:
receiving a signal from the first radio node;
removing an affix from the received signal resulting in n sequences of k received samples;
stacking the n sequences of k received samples;
decoding the stacked n sequences of k received samples using n orthogonal code sequences, wherein each code sequence comprises n code elements, wherein for each code sequence each of the n sequences of k received samples is multiplied to one out of the n code elements of the code sequence and wherein the multiplied sequences of received samples are subsequently added, and wherein the decoding results in n different decoded sequences of samples of length k each decoded sequence of samples corresponding to one of the n applied code sequences; and
extracting a sequence of data symbols S₀, S₁, . . . , Sₖ₋₁ from the n different decoded sequences of samples.

45. A first radio node for transmitting a signal comprising encoded data symbols to a second radio node, wherein the first radio node and the second radio node are operating in a wireless communications, and wherein the first radio node is configured to:
repeat n times a sequence of data symbols S₀, S₁, . . . , Sₖ₋₁ to be transmitted, wherein k is a multiple of n;
encode the n sequences of data symbols S₀, S₁, . . . , Sₖ₋₁ using n orthogonal code sequences, wherein each code sequence comprises n code elements; and
transmit, to the second radio node, a signal comprising the respective encoded sequence of data symbols S₀, S₁, . . . , Sₖ₋₁ and an optional respective affix for separating two encoded sequences of data symbols S₀, S₁, . . . , Sₖ₋₁.

46. The first radio node of claim 45, being configured to encode the n sequences of data symbols S₀, S₁, . . . , Sₖ₋₁ by further being configured to:
element-wise multiply one code sequence out of the n orthogonal code sequences to the n times repeated data symbol Si comprised in the n sequences of data symbols S₀, S₁, . . . , Sₖ₋₁ wherein i ϵ[0,1, . . . , k-1].

47. The first radio node of claim 45, being configured to encode the n sequences of data symbols S₀, S₁, . . . , Sₖ₋₁ by further being configured to:
repeatedly use the n orthogonal code sequences for the encoding of the n sequences of data symbols S₀, S₁, . . . , Sₖ₋₁, wherein the n orthogonal code sequences are used k/n times each for encoding n times repeated symbol S₁ comprised in the n sequences of data symbols S₀, S₁, . . . , Sₖ₋₁, wherein i ϵ[0,1, . . . , k-1].

48. The first radio node of claim 45, being configured to:
provide the respective affix before the first data symbol SO of each encoded sequence of data symbols S₀, S₁, . . . , Sₖ₋₁.

49. The first radio node of claim 48, being configured to provide the respective affix by further being configured to:
insert a respective cyclic prefix before the first data symbol So of each encoded sequence of data symbols S₀, S₁, . . . , Sₖ₋₁, wherein the respective cyclic prefix comprises one or more of the last n−1 data symbols of the respective encoded sequence of data symbols S₀, S₁, . . . , Sₖ₋₁.

50. The first radio node of claim 48, being configured to provide the respective affix by further being configured to:
provide a respective guard time period before the first data symbol So of each encoded sequence of data symbols S₀, S₁, . . . , Sₖ₋₁.

51. The first radio node of claim 45, wherein the data symbols S₀, S₁, . . . , Sₖ₋₁ are data symbols from a symbol constellation of a linear modulation or a non-linear modulation.

52. The first radio node of claim 51, wherein the linear modulation is one out of:
a Phase-Shift Keying, PSK; and
a Quadrature Amplitude Modulation, QAM.

53. The first radio node of claim 51, wherein the non-linear modulation is one out of:
a Gaussian Minimum Shift Keying, GMSK;
a Gaussian Frequency-Shift Keying, GFSK; and
a Minimum-Shift Keying, MSK.

54. The first radio node of claim 45, wherein one or more of the data symbols S₀, S₁, . . . , Sₖ₋₁ are training symbols.

55. The first radio node of claim 45, wherein the n orthogonal code sequences comprise real values.

56. The first radio node of claim 55, wherein the n orthogonal code sequences are comprised in an n by n Hadamard matrix.

57. The first radio node of claim 45, wherein the n orthogonal code sequences comprise complex values.

58. The first radio node of claim 45, being configured to transmit the signal comprising the respective affix and the respective encoded sequence of data symbols S₀, S₁, . . . , Sₖ₋₁ by further being configured to:
transmit the respective affix and the respective encoded sequence of data symbols S₀, S₁, . . . , Sₖ₋₁ in sequence using a single carrier; or
transmit the respective affix and the respective encoded sequence of data symbols S₀, S₁, . . . , Sₖ₋₁ in parallel using a respective subcarrier in a multicarrier signal.

59. The first radio node of claim 45, wherein the first radio node is configured to repeat n times of the sequence of data symbols S₀, S₁, . . . , Sₖ₋₁ by being configured to:
generate an n by k matrix, wherein each row is a copy of a sequence of data symbols S₀, S₁, . . . , Sₖ₋₁, wherein n is the number of repetitions of the sequence of data symbols S₀, S₁, . . . , Sₖ₋₁; wherein the first radio node is configured to encode the n sequences of data symbols S₀, S₁, . . . , Sₖ₋₁ using n orthogonal code words by being configured to:
encode the generated n by k matrix by performing element-wise matrix multiplication using an k/n times repeated n by n orthogonal code matrix comprising the n orthogonal code sequences, wherein the encoding results in an encoded n by k matrix; wherein the first radio node is configured to provide the respective affix by being configured to:
insert a cyclic prefix before the encoded n by k matrix, which cyclic prefix comprises one or more of the last n−1 columns of the encoded n by k matrix, wherein the inserting results in an n by (x+k) matrix, wherein x is the number of columns of the inserted cyclic prefix, or
provide a respective guard time period before the first data symbol So of each encoded sequence of data symbols S₀, S₁, . . . , Sₖ₋₁; and wherein the first radio node is configured to transmit the respective affix and the respective sequence of data symbols S₀, S₁, . . . , Sₖ₋₁ by being configured to:
transmit row wise the respective affix and the data symbols S₀, S₁, . . . , Sₖ₋₁ comprised in the n by (x+k) matrix.

60. A second radio node for decoding and extracting data symbols from a received signal, wherein the second radio node and a first radio node are operating in a wireless communications network, and wherein the second radio node is configured to:
receive a signal from the first radio node;
remove an affix from the received signal resulting in n sequences of k received samples;
stack the n sequences of k received samples;
decode the stacked n sequences of k received samples using n orthogonal code sequences, wherein each code sequence comprises n code elements, wherein for each code sequence each of the n sequences of k received samples is multiplied to one out of the n code elements of the code sequence and wherein the multiplied sequences of received samples are subsequently added, and wherein the decoding results in n different decoded sequences of samples of length k each decoded sample corresponding to one of the n applied code sequences; and
extract a sequence of data symbols S₀, S₁, . . . , Sₖ₋₁ from the n different decoded sequences of samples.

61. The second radio node of claim 60, being configured to:
reorder the n different decoded sequences of samples and possibly moving elements between the n different decoded sequences of samples to obtain n different decoded and reordered sequences of samples.

62. The second radio node of claim 60, being configured to:
estimate n channel coefficients h₀, h₁, . . . hₙ₋₁ wherein each one of the n different decoded sequences of samples corresponds to the sequence of data symbols S₀, S₁, . . . , Sₖ₋₁ multiplied by a respective channel coefficient.

63. The second radio node of claim 60, being configured to:
combine the n different decoded sequences of samples by performing a Maximum Ratio Combination (MRC), whereby the signal to noise ratio is increased.

64. The second radio node of claim 60, wherein second radio node is configured to stack the n sequences of k received samples by being configured to:
stack the n sequences of k received samples into a first n by k matrix; wherein second radio node is configured to decode the stacked sequences of k received samples using n orthogonal code sequences by being configured to:
decode the first n by k matrix using an n by n orthogonal code matrix comprising the n orthogonal code sequences, wherein each code sequence comprises n code elements and wherein the decoding results in a second n by k matrix; and
wherein second radio node is configured to extract the sequence of data symbols S₀, S₁, . . . , Sₖ₋₁ from the n different decoded sequences of samples by being configured to extract the sequence of data symbols S₀, S₁, . . . , Sₖ₋₁ from the second n by k matrix.
